(19) United States
(12) Patent Application Publication
(10) Pub. No.: US 2019/0005696 A1
(43) Pub. Date: Jan. 3, 2019

(54) Semantic Vector Tiles

(71) Applicant: Google LLC, Mountain View, CA (US)

(72) Inventors: James Mccloskey, Pyrmont (AU); Jorrit Herder, Wollstonecraft (AU); Mackenzie Jacoby, Pyrmont (AU)

(21) Appl. No.: 15/809,395

(22) Filed: Nov. 10, 2017

Related U.S. Application Data
(60) Provisional application No. 62/528,171, filed on Jul. 3, 2017.

(51) Int. Cl. G06T 11/60

(52) U.S. Cl. CPC G06T 11/60; H04L 67/146

(57) ABSTRACT

Systems and methods for serving a vector tile are provided. In one embodiment, a method includes receiving a request for information associated with a geographic area. The method includes, in response to the request, accessing a vector tile associated with the geographic area. The vector tile can comprise vector data representing a feature in the geographic area and semantic metadata corresponding to the vector data. The semantic metadata can provide information associated with the vector data representing the one or more objects. The method includes serving the vector tile comprising the vector data and the semantic metadata.

### PRIORITY CLAIM

This application claims priority to U.S. Patent Application Ser. No. 62/528,171, filed Jul. 3, 2017, and entitled “SEMANTIC VECTOR TILES,” the disclosure of which is incorporated by reference herein in its entirety.

### FIELD

The present disclosure relates generally to a mapping system based on vector tiles, and more particularly to a mapping system based on semantic vector tiles including vector data and semantic metadata.

### BACKGROUND

Tiles can be utilized to deliver geographic data to a browser or application for rendering as a map image. For example, raster tiles can include images of geographic locations and their respective features. Similarly, vector tiles can include vector representations of the features of a geographic location. For example, a vector tile can include a polyline specifying the shape and location of a given road or a vector tile can include a polygon specifying the shape and location of a given body of water. One advantage of vector tiles is their size, as they are often capable of efficiently describing the geographic features of a given location.

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of serving a vector tile. The method includes receiving a request for information associated with a geographic area. The method further includes, in response to the request, accessing a vector tile including vector data representing a feature in the geographic area and semantic metadata corresponding to the vector data. The semantic metadata can provide information associated with the vector data representing the one or more objects. The method further includes serving the vector tile including the vector data and the semantic metadata.

Other example aspects of the present disclosure are directed to systems, apparatuses, tangible, non-transitory computer-readable media, user interfaces, memory devices, and electronic devices for serving a vector tile, generating a vector tile, or providing for display a map image based on a vector tile.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example computing environment according to example embodiments of the present disclosure;

FIG. 2 depicts an example map image according to example embodiments of the present disclosure;

FIG. 3 depicts an example semantic vector tile according to example embodiments of the present disclosure;

FIG. 4 depicts an example event sequence according to example embodiments of the present disclosure;

FIG. 5 depicts a flow chart diagram of an example method for generating a semantic vector tile according to example embodiments of the present disclosure;

FIG. 6 depicts a flow chart diagram of an example method for displaying a map image based on a semantic vector tile according to example embodiments of the present disclosure; and

FIG. 7 depicts a flow chart diagram of an example method for serving a semantic vector tile according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to generating semantic vector tiles and for displaying map images based on semantic vector tiles. For example, the systems and methods of the present disclosure can be used to generate and/or serve semantic vector tiles including map data (e.g., vector data representing geographic features and their geometries) and corresponding semantic metadata (e.g., information about the types of geographic features and/or relations between these features (e.g., a point of interest can occupy a building and/or region)). The map data can include one or more vector representations of one or more geographic features. A vector representation can include a geometric representation of an object (e.g., polyline, shape, etc.). For example, in accordance with aspects of the disclosure, an example semantic vector tile can provide semantic information and encode that there is a geographical entity of a particular type (e.g., a river, and/or the like), as well as include other metadata (e.g., a shape, name, prominence, and/or the like associated with the entity).

In some implementations, a user device can request a localized vector tile corresponding to a particular geographic location (e.g., geographic coordinates). A computing system can identify, based on the geographic location, map data associated with the geographic location. For example, the computing system can identify vector data corresponding to geographic features associated with the geographic location and their respective geometries. The computing system can further identify semantic metadata corresponding to the map data. For example, the map data can include data describing a road (e.g., vector data describing the geometry of a road), and the computing system can identify semantic metadata indicating the type of road (e.g., whether the road is a local road, a major arterial road, a primary highway, or the like). The computing system can utilize the map data and the semantic metadata to generate a vector tile including the map data (e.g., vector data representing geographic features and their respective geometries) and the semantic metadata (e.g., information about the type of geographic features). The computing system can communicate the vector tile including the map data and the semantic metadata to the user device in response to the request, and the user device can process the vector tile. For example, the user device can render and/or provide for display a map image based on the map data and semantic metadata (e.g., an image depicting the geographic features and one or more elements generated based on the semantic metadata).

In some implementations, the vector tile can include multiple logical layers. For example, the vector tile can include layers corresponding to roads, buildings, structures, transit infrastructure, land use, water, points of interest and/or other layers. In such implementations, each layer can include elements of a feature associated with the layer. For example, a layer corresponding to roads can include multiple elements, with each element corresponding to a different road. Similarly, a layer corresponding to buildings can include multiple elements, with each element corresponding to a different building. For each element of the feature, the vector tile can include semantic metadata indicating a type of the feature (e.g., a road type, a building use, a type of transit infrastructure, a type of land use, a type of water body, a prominence of a point of interest, or the like). For example, the layer corresponding to roads can include semantic metadata indicating a type of road (e.g., whether the road is a local road, a major arterial road, a primary highway, or the like) for each element of the layer. Similarly, the layer corresponding to buildings can include semantic metadata indicating a type of building for each element of the layer, for example, the dominant use of the building (e.g., shopping, lodging, food and drink, bar, entertainment, arts, or the like).

In some implementations, the request received from the user device can specify a feature type. For example, the request received from the user device can specify to only return roads layer data or even the road type “major arterial road.” In such implementations, the computing system can be configured to serve the vector tile such that elements of the data returned are filtered based on the feature type. For example, the computing system can serve the vector tile such that the layer corresponding to roads only contains map data for roads of the type “major arterial road.”

In some implementations, the map data can include map vector tiles. In such implementations, the computing system can utilize the semantic metadata to convert the map vector tiles into semantic vector tiles including the map data (e.g., the geographic features and geometries stored in the map vector tiles) and the semantic metadata.

The methods and systems described herein can provide a number of technical effects and benefits. For instance, the provision of vector tiles including semantic metadata in addition to map data in the manner described herein can allow for a more semantically meaningful map to be displayed by a client apparatus. The semantic metadata can provide more meaningful information concerning the map data contained by the vector tile, for example a type of road contained by the vector tile, a type of building, a type of transit, a land use or a type of body of water. Such semantic metadata can be processed by the client apparatus to provide valuable content to a user. Additionally or alternatively, a client can utilize such semantic metadata to dynamically style a map, perform client-side filtering (e.g., based on feature type, and/or the like), assist in performing user queries, and/or the like.

The provision of semantic metadata in the vector tile can mean that the client apparatus does not need to acquire semantic information from one or more different sources to the source of the map data. The amount of traffic incurred by requests going back and forth between client and server to acquire semantic information can be reduced. Also, the number of user inputs required by the user of the client apparatus to request semantic information for the map can also be reduced, again reducing network traffic. As a result of the reduced number of inputs, the user can be able to spend less time using the application, which can reduce screen-on time, thereby reducing power usage.

In some examples, by providing the semantic metadata in a plurality of layers of the vector tile, the type of semantic metadata provided to the client apparatus and/or used by the client apparatus can be easily and intuitively selected or filtered. Receiving a request including a request for one or more of the layers, and hence one or more of the types of metadata, can allow for the server apparatus to serve a vector tile comprising semantic metadata that is of particular use to the client apparatus. This can reduce traffic between the client and server that can otherwise have included the exchange of unnecessary semantic metadata. Furthermore, it can allow for a reduction in processing on the client side, with associated reductions in power usage on the client side. This can be of particular benefit if the client apparatus has a limited power supply, for example if the client apparatus is a mobile device.

One example embodiment of the present disclosure is directed to a method of operating a server apparatus can include receiving a request for a semantic vector tile. The method can further include retrieving map data based on the received request. The method can further include retrieving semantic metadata associated with the map data. The method can further include serving the semantic vector tile to a client apparatus. The semantic vector tile can comprise the map data and the semantic metadata.

Variations and modifications can be made to this example embodiment. For instance. In some implementations, the request can be received from the client apparatus. The request can comprise geospatial coordinates (e.g., latitude and longitude coordinates, map tile coordinates, and/or the like), and the retrieved map data can correspond to the geospatial coordinates.

In some implementations, the semantic vector tile can comprise a plurality of layers. At least one layer of the plurality of layers can comprise the semantic metadata. In such implementations, receiving the request for the vector tile can comprise receiving a request for the at least one layer of the plurality of layers, and the served vector tile can comprise the at least one layer of the plurality of layers. In some implementations, at least one layer of the plurality of layers can comprise an epoch value, tile version, expiration time, and/or the like.

In some implementations, retrieving the map data can comprise retrieving a map vector tile comprising the map data. In such implementations, the map vector tile can be converted using the semantic metadata to generate the served vector tile. In some implementations, a session token can be provided to the client apparatus prior to receiving the request. In such implementations, the request can comprise the session token.

Another example embodiment of the present disclosure is directed to a computer-implemented method of serving a semantic vector tile. The method can include receiving, by one or more computing devices, a request for information associated with a geographic area. In response to the request, the method can include accessing, by the one or more computing devices, a semantic vector tile associated with the geographic area. The semantic vector tile can include vector data representing a feature in the geographic area and semantic metadata corresponding to the vector data. The semantic metadata can provide information associated with the vector data representing the one or more objects. The method can include serving, by the one or more computing devices, the semantic vector tile comprising the vector data and the semantic metadata.

In some embodiments, the vector data can include a vector representation (e.g., data associated with a geometric representation) of the feature in the geographic area. In some embodiments, the semantic metadata includes an identifier providing identification information associated with the feature in a geographic information system (e.g., an identifier that can be utilized to retrieve information about the feature, and/or the like).

In some embodiments, the semantic vector tile includes a plurality of layers. The semantic metadata can include semantic metadata for each layer of the plurality of layers. For instance, for each layer, the layer can include elements of a feature. The semantic metadata for the layer can include, for each element of the feature, a type of the feature. For instance, for at least one layer, the type of feature can include one or more of a road, building, structure, transit infrastructure, land use, water, natural feature, or point of interest. In some implementations, the semantic metadata comprises an indicator of at least one of a road type, a building use, a type of transit infrastructure, a type of land use, a type of water body, or a prominence of a point of interest.

In some embodiments, the request can specify a type of feature. Accessing the semantic vector tile can include filtering elements of the semantic vector tile based on the type of feature.

In some embodiments, the method can include utilizing semantic metadata to convert a map vector tile into the semantic vector tile. For instance, a vector tile associated with a geographic area can be accessed. The vector tile can include vector data. The vector data can be enriched with semantic metadata associated with one or more features represented by the vector data to generate a semantic vector tile.

Another example embodiment of the present disclosure is directed to a computing system for generating a semantic vector tile. The computing system can include at least one processor. The computing system can include at least one tangible, non-transitory computer-readable medium that stores instruction that when executed by the at least one processor cause the computing system to perform operations. The operations can include receiving a request for a semantic vector tile; identifying vector data corresponding to the request; identifying semantic metadata corresponding to the vector data; and utilizing the vector data and the semantic metadata to generate a semantic vector tile. The semantic vector data can include one or more layers. For each layer, the vector tile can include semantic metadata for the layer.

Another example embodiment of the present disclosure is directed to one or more tangible, non-transitory computer-readable media storing computer-readable instructions that when executed by one or more processors cause the one or more processors to perform operations, the operations can include requesting a semantic vector tile corresponding to a geographic location. The operations can include receiving a semantic vector tile comprising vector data and semantic metadata. The vector data can correspond to the geographic location, and the semantic metadata can correspond to the vector data. The method can include providing for display information associated with the semantic vector tile.

Some embodiments of the present disclosure are directed to a server apparatus configured to perform any of the methods disclosed herein. Some embodiments of the present disclosure are directed to a computer program product configured to perform any of the methods or operations disclosed herein.

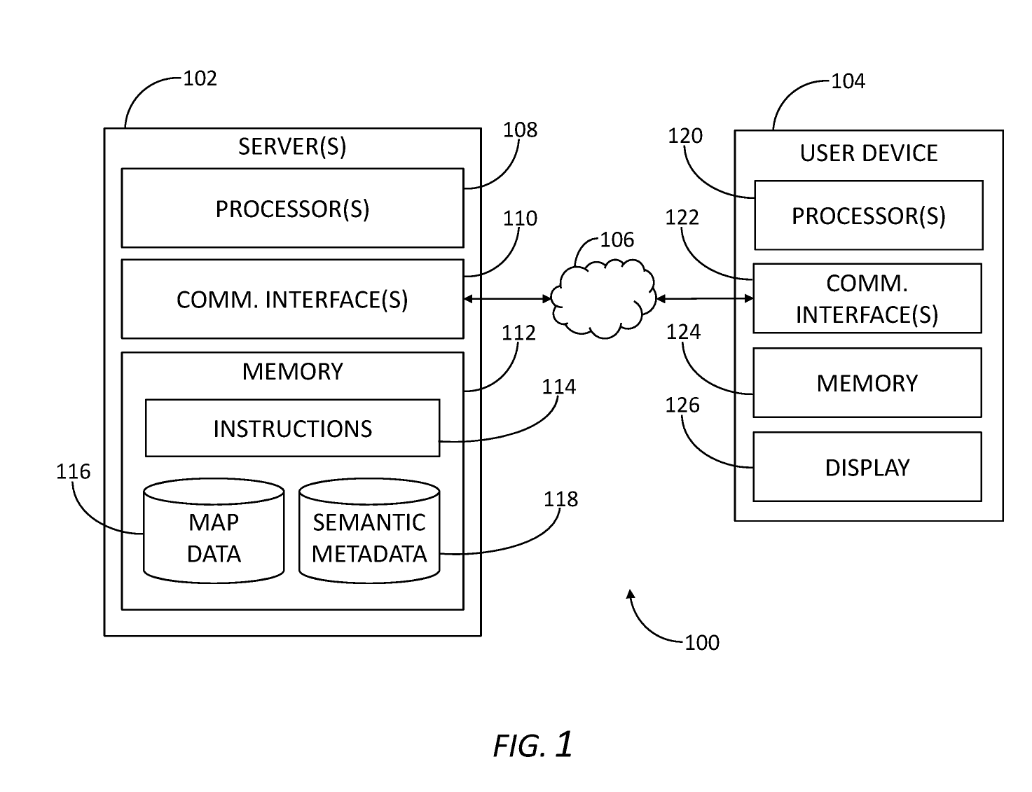

FIG. 1 depicts an example computing environment according to example embodiments of the present disclosure. Referring to FIG. 1, environment 100 can include one or more computing devices. For example, environment 100 can include one or more servers 102 and user device 104. Server(s) 102 can include any type of computing device capable of performing operations described herein. For example, server(s) 102 can include one or more computers, blades, mainframes, virtualized computing environments, or the like. User device 104 can include any type of computing device capable of performing operations described herein. For example, user device 104 can include a personal computer, laptop computer, tablet computer, mobile device, smartphone, wearable device, display with one or more processors, or the like. Environment 100 can also include one or more networks 106. Network(s) 106 can interface server(s) 102 and user device 104. Network(s) 106 can include one or more subnetworks (e.g., local area networks (LANs), wide area networks (WANs), virtual private networks (VPNs), or the like).

Server(s) 106 can include one or more processors 108, communication interfaces 110, and memory 112. Memory 112 can store instructions 114, which, when executed by processor(s) 108, can cause server(s) 102 to perform one or more functions described herein. As will be described in greater detail below, memory 112 can also store map data 116 (e.g., vector data) and/or semantic metadata 118. Communication interface(s) 110 can be configured to enable server(s) 102 to communicate with one or more other computing devices of environment 100 (e.g., user device 104) via network(s) 106. User device 104 can include one or more processors 120, communication interfaces 122, memory 124, and display 126. Memory 124 can store instructions, which, when executed by processor(s) 120, can cause user device 104 to perform one or more functions described herein. Communication interface(s) 122 can be configured to enable user device 104 to communicate with one or more other computing devices of environment 100 (e.g., server(s) 102) via network(s) 106. Display 126 can include any type of display that can provide an image (e.g., a map image) for viewing by a user of user device 104.

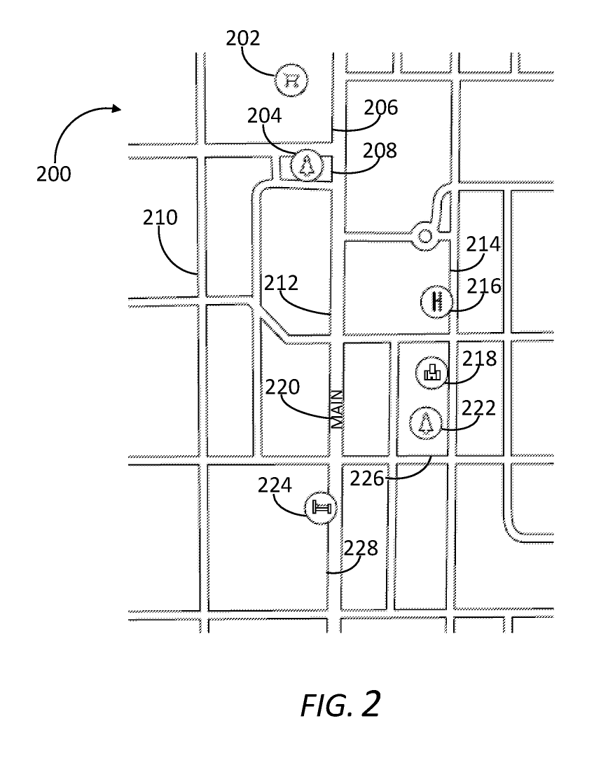

FIG. 2 depicts an example map image according to example embodiments of the present disclosure. Referring to FIG. 2, image 200 can include one or more features (e.g., roads, buildings, structures, transit infrastructure, land, water, points of interests, or the like). For example, image 200 can include elements 210 and 212 corresponding to roads. Similarly, image 200 can include elements 206, 208, 214, 226, and 228 corresponding to land (e.g., blocks). The elements 206, 208, 214, 216, and 228 can be represented using vector data. Image 200 can also include one or more elements corresponding to semantic information. For example, image 200 can include element 220, which can depict a road name for the road corresponding to element 212. Similarly, image 200 can include elements 202, 204, 216, 218, 222, and 224, which can depict use types for land, buildings, or structures for the land corresponding to elements 206, 208, 214, 226, and 228, respectively. According to example aspects of the present disclosure, semantic vector tiles can be used to provide vector information and semantic information for the example map image of FIG. 2.

In some embodiments, a semantic vector tile can include data specifying coordinates (e.g., geographic coordinates associated with the semantic vector tile) as well as semantic vector tile contents. The semantic vector tile contents can be organized into layers. Each layer can include data specifying a feature type (e.g., roads, transit lines, building structures, natural features, points of interest, etc.) Each layer can include data associated with a geographic feature, such as data identifying the feature (e.g., an ID) and feature rank data indicative of a relative importance of the feature. The data associated with each feature in the layer can include geometry (e.g., points, lines, areas, volumes) representing the feature. The data associated with each feature can also include semantic information associated with the feature.

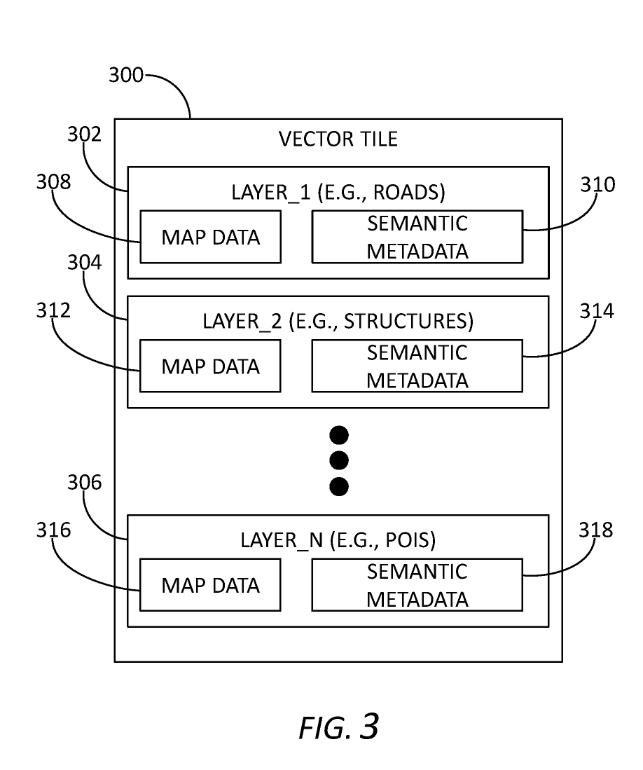

FIG. 3 depicts an example semantic vector tile according to example embodiments of the present disclosure. In some embodiments, vector tile 300 can comprise structured data (e.g., protocol buffers, JSON, XML, and/or the like). Vector tile 300 can include layers 302, 304, and 306. Each of layers 302, 304, and 306 can correspond to a feature (e.g., roads, buildings, structures, transit infrastructure, land use, water, points of interests (POIs), or the like). For example, layer 302 can correspond to roads, layer 304 can correspond to structures, and layer 306 can correspond to POIs. Each of layers 302, 304, and 306 can include map data (e.g., vector data) that represents elements of its corresponding feature (e.g., geographic features and their respective geometries). For example, layer 302 can include map data 308, which can represent various roads. Similarly, layer 304 can include map data 312, which can represent various structures, and layer 306 can include map data 316 which can represent various POIs.

In accordance with aspects of the disclosure, each of layers 302, 304, and 306 can also include semantic metadata, which can indicate, for example, feature types of the individual elements of the various features represented by the map data of vector tile 300. For example, layer 302 can include semantic metadata 310, which can indicate the various different types of roads (e.g., whether the road is a local road, a major arterial road, a primary highway, or the like) of the roads represented by map data 308. Similarly, layer 304 can include semantic metadata 314, which can indicate the various different types of structures of the structures represented by map data 312, and layer 306 can include semantic metadata 318, which can indicate the various different types of POIs represented by map data 316. In some implementations, one or more of layers 302, 304, or 306 can include an epoch value, tile version, expiration time, and/or the like. For example, one or more of layers 302, 304, or 306 can include a value indicating when the layer was created or a time at which the layer expires (e.g., a time at which a user device should request on updated vector tile comprising a new version of the layer).

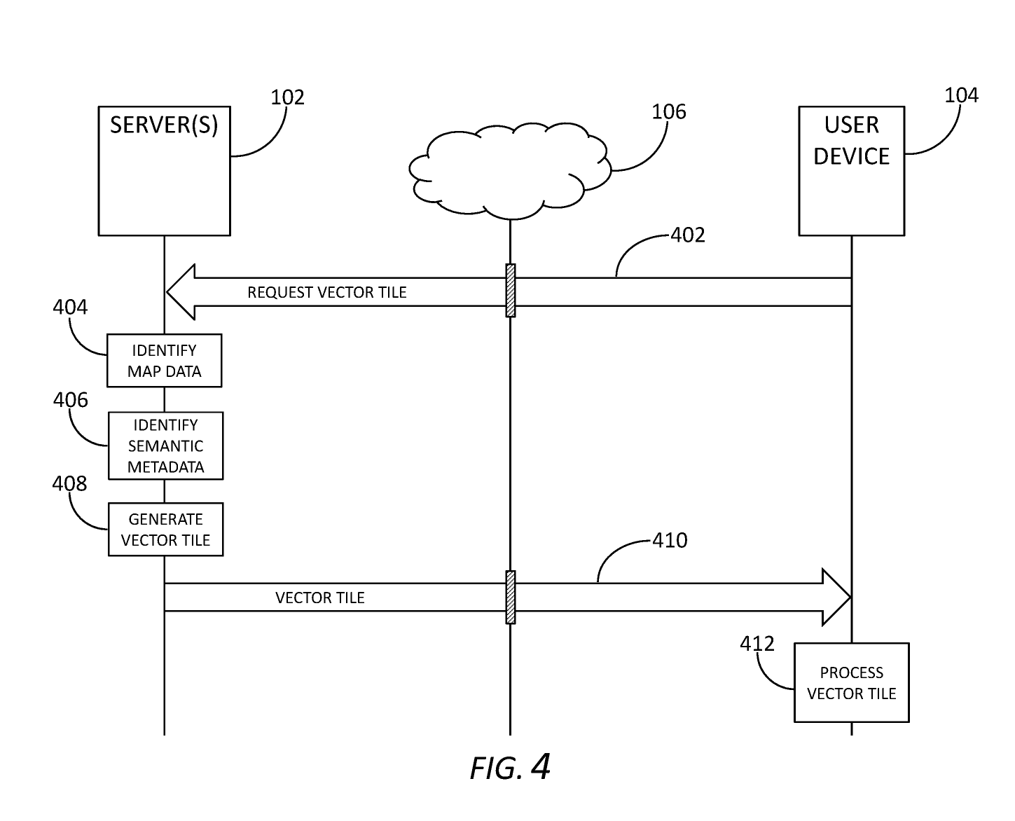

FIG. 4 depicts an example event sequence according to example embodiments of the present disclosure. Referring to FIG. 4, at (402), user device 104 can request a semantic vector tile corresponding to a given geographic location (e.g., the request can include coordinates corresponding to a given geographic location). For example, server(s) 102 can host an application programming interface (API) configured to provide semantic vector tiles in response to requests from user devices (e.g., user device 104), and user device 104 can generate a request using the API and communicate the request to server(s) 102 via network(s) 106. As will be described in greater detail below, in some implementations, the request can specify a feature and/or type of feature. For example, the request can specify roads and/or major arterial roads. In some implementations, the request can include a session token. For example, server(s) 102 can have previously established a session with user device 104 and communicated a session token to be included in requests associated with the session, and user device 104 can have included the session token in the request.

Server(s) 102 can receive the request from user device 104 and, at (404), can identify map data corresponding to the geographic location from amongst map data 116. For example, the request can specify a location corresponding to the location depicted by image 200, and server(s) 102 can identify map data (e.g., vector data) corresponding to elements 206, 208, 210, 212, 214, 226, and 228 (e.g., data representing geographic elements corresponding to elements 206, 208, 210, 212, 214, 226, and 228, and their respective geometries). At (406), server(s) 102 can identify semantic metadata corresponding to the identified map data (e.g., the map data corresponding to the geographic location). For example, server(s) 102 can identify semantic metadata corresponding to elements 202, 204, 216, 218, 220, 222, and 224 of image 200 from amongst semantic metadata 118. In some implementations, the semantic metadata can include an identifier corresponding to an entry in a table of places (e.g., as part of a geographic information system). For example, server(s) 102 can host an API corresponding to a database of places, and the semantic metadata can include an identifier that can be utilized to retrieve data from the database of places.

At (408), server(s) 102 can serve a semantic vector tile comprising the identified map data (e.g., the map data corresponding to the geographic location) and the identified semantic metadata (e.g., the semantic metadata corresponding to the identified map data). For example, server(s) 102 can serve a vector tile similar to vector tile 300. As indicated above, vector tile 300 can include multiple layers, with each layer corresponding to a different kind of feature and comprising map data representing elements of the feature and semantic metadata indicating types of the feature for the various elements. For example, layer 302 can correspond to roads, map data 308 can include vector representations of roads corresponding to elements 210 and 212 of image 200 and their respective geometries, and semantic metadata 310 can indicate the types of roads represented by map data 308. As indicated above, in some implementations, the request received from user device 104 can specify a feature and/or type of feature. For example, the request can specify roads and/or major arterial roads. In such implementations, server(s) 102 can serve a vector tile comprising map data and corresponding semantic metadata by filtering elements of the feature (e.g., roads) based on the feature type (e.g., major arterial roads). For example, server(s) 102 can serve a vector tile comprising map data for only major arterial roads located at the geographic location.

At (410), server(s) 102 can communicate the vector tile to user device 104 via network(s) 106. User device 104 can receive the semantic vector tile and, at (412), can process the semantic vector tile (e.g., provide for display via display 126 a map image based on the map data and semantic metadata). For example, user device 104 can provide for display via display 126 image 200.

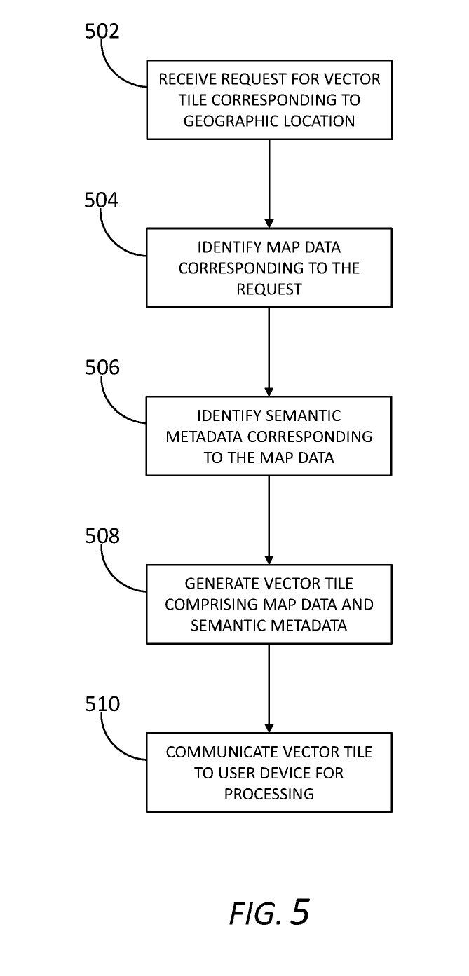

FIG. 5 depicts a flow chart diagram of an example method for generating a semantic vector tile according to example embodiments of the present disclosure. Referring to FIG. 5, at (502), a request for a vector tile corresponding to a geographic location can be received. For example, server(s) 102 can receive a request for a vector tile corresponding to a geographic location (e.g., geographic coordinates) from user device 104 via network(s) 106. At (504), map data (e.g., vector data) corresponding to the request can be identified. For example, server(s) 102 can identify, from amongst map data 116, map data corresponding to the geographic location (e.g., vector data representing one or more geographic features of the location and their respective geometries). At (506), semantic metadata corresponding to the identified map data can be identified. For example, server(s) 102 can identify, from amongst semantic metadata 118, semantic metadata, for example, data indicating types of the geographic features (e.g., road types, building use types, transit infrastructure types, types of land use, types of water bodies, prominences of POIs, or the like) corresponding to the identified map data.

At (508), a vector tile comprising the map data and semantic metadata can be generated. For example, server(s) 102 can generate a vector tile comprising the identified map data (e.g., the data describing the geographic feature(s) of the location and their respective geometries) and the identified semantic metadata (e.g., data indicating the types of the geographic features).

In some implementations, map data 116 can include vector tiles. In such implementations, server(s) 102 can identify a vector tile corresponding to the geographic location and can utilize the identified semantic metadata to convert the vector tile corresponding to the geographic location into a semantic vector tile comprising the map data (e.g., map data from the vector tile corresponding to the geographic location) and the semantic metadata. At (510), the vector tile comprising the map data and the semantic metadata can be communicated to a user device for processing. For example, server(s) 102 can communicate the vector tile comprising the map data and the semantic metadata to user device 104, which can receive the vector tile and process the vector tile (e.g., render an image based on the map data and the semantic metadata (e.g., an image depicting the geographic features, their respective geometries, and the type of the geographic features)).

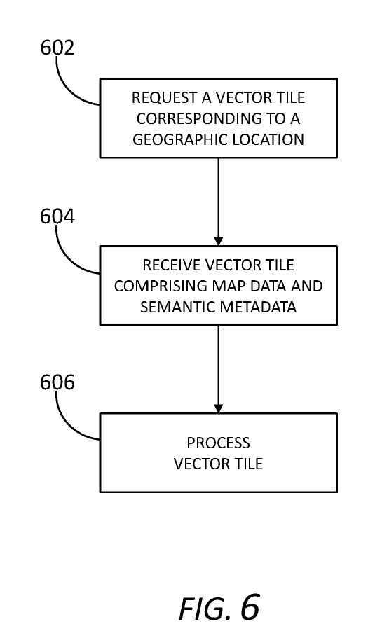

FIG. 6 depicts a flow chart diagram of an example method for displaying a map image based on a semantic vector tile according to example embodiments of the present disclosure. Referring to FIG. 6, at (602) a semantic vector tile corresponding to a geographic location can be requested. For example, user device 104 can generate a request for a semantic vector tile corresponding to a geographic location (e.g., geographic coordinates) and can communicate the request to server(s) 102 via network(s) 106. At (604), a vector tile comprising map data (e.g. vector data) and semantic metadata can be received. For example, user device 104 can receive a vector tile comprising map data (e.g., data representing geographic features of the location and their respective geometries) and semantic metadata (e.g., data indicating types of the geographic features) from server(s) 102 via network(s) 106. At (606), the vector tile can be processed (e.g., a map image based on the vector tile can be displayed). For example, user device 104 can render a map image of the geographic location based on the map data and semantic metadata, and user device 104 can provide the map image for display via display 126.

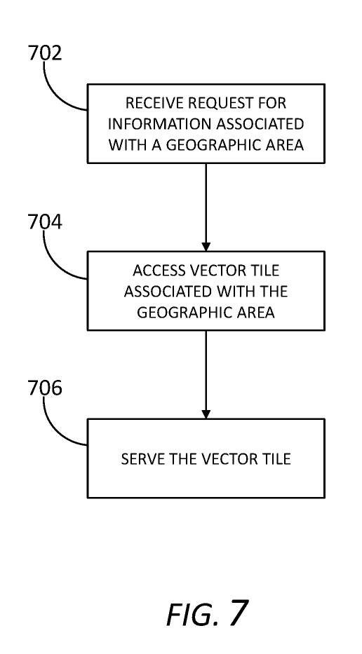

FIG. 7 depicts a flow chart diagram of an example method for serving a semantic vector tile according to example embodiments of the present disclosure. Referring to FIG. 7, at (702), a request for information associated with a geographic area can be received. For example, server(s) 102 can receive a request for information associated with a geographic area depicted by image 200 from user device 104 via network(s) 106. At (704), in response to the request, a semantic vector tile associated with the geographic area can be accessed. For example, in response to the request received from user device 104, server(s) 102 can access semantic vector tile 300, which can be associated with the geographic area depicted by image 200. The semantic vector tile can comprise vector data representing a feature in the geographic area and semantic metadata corresponding to the vector data, and the semantic metadata can provide information associated with the vector data representing the one or more objects. For example, map data 308 can comprise vector data (e.g., a polyline) representing the road corresponding to element 212, and semantic metadata 310 can comprise semantic metadata corresponding to element 220, for example, metadata indicating the name of the road corresponding to element 212 or the type (e.g., major arterial) of the road corresponding to element 212. At (706), the semantic vector tile comprising the vector data and the semantic metadata can be served. For example, server(s) 102 can serve vector tile 300 to user device 104 (e.g., to a browser or application executing on user device 104).

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

Furthermore, computing tasks discussed herein as being performed at a server can instead be performed at a user device. Likewise, computing tasks discussed herein as being performed at the user device can instead be performed at the server.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of serving a semantic vector tile, the method comprising:
receiving, by one or more computing devices, a request for information associated with a geographic area;
in response to the request, accessing, by the one or more computing devices, a semantic vector tile associated with the geographic area, the semantic vector tile comprising vector data representing a feature in the geographic area and semantic metadata corresponding to the vector data, the semantic metadata providing information associated with the vector data representing the one or more objects; and
serving, by the one or more computing devices, the semantic vector tile comprising the vector data and the semantic metadata.

2. The method of claim 1, wherein the vector data comprises a vector representation of the feature in the geographic area.

3. The method of claim 1, wherein the semantic metadata comprises an identifier providing identification information associated with the feature in a geographic information system.

4. The method of claim 1, wherein the semantic vector tile comprises a plurality of layers, and wherein the semantic metadata comprises semantic metadata for each layer of the plurality of layers.

5. The method of claim 4, wherein, for each layer, the layer comprises elements of a feature, and the semantic metadata for the layer comprises, for each element of the feature, a type of the feature.

6. The method of claim 5, wherein, for at least one layer, the type of the feature comprises one or more of a road, building, structure, transit infrastructure, land use, water, natural feature, or point of interest.

7. The method of claim 5, wherein the request specifies a type of feature, and wherein accessing the semantic vector tile comprises filtering elements of the semantic vector tile based on the type of feature.

8. The method of claim 1, wherein the method comprises utilizing the semantic metadata to convert a map vector tile into the semantic vector tile comprising the vector data and the semantic metadata.

9. The method of claim 1, wherein the semantic metadata comprises an indicator of at least one of a road type, a building use, a type of transit infrastructure, a type of land use, a type of water body, or a prominence of a point of interest.

10. The method of claim 1, wherein receiving the request comprises receiving the request from a user device, the method further comprising communicating, by the one or more computing devices, the semantic vector tile to the user device.

11. The method of claim 10, wherein the request comprises a session token, the method further comprising communicating, by the one or more computing devices, the session token to the user device.

12. A computing system for generating a semantic vector tile, the computing system comprising:
at least one processor; and
at least one tangible, non-transitory computer-readable medium that stores instructions that, when executed by the at least one processor, cause the computing system to:
receive a request for a semantic vector tile;
identify vector data corresponding to the request;
identify semantic metadata corresponding to the vector data; and
utilize the vector data and the semantic metadata to generate a semantic vector tile comprising one or more layers, wherein, for each layer, the vector tile comprises semantic metadata for the layer.

13. The computing system of claim 12, wherein, for each layer, the layer comprises elements of a feature, and the semantic metadata for the layer comprises, for each element of the feature, a type of the feature.

14. The computing system of claim 13, wherein, for at least one layer, the feature comprises one or more of roads, buildings, structures, transit infrastructure, land use, water, or points of interest.

15. The computing system of claim 13, wherein the request specifies a type of feature, and wherein the instructions further cause the computing system to filter elements of the feature based on the type of feature.

16. The computing system of claim 12, wherein the semantic metadata comprises an indicator of at least one of a road type, a building use, a type of transit infrastructure, a type of land use, a type of water body, or a prominence of a point of interest.

17. One or more tangible, non-transitory computer-readable media storing computer-readable instructions that when executed by one or more processors cause the one or more processors to perform operations, the operations comprising:
requesting a semantic vector tile corresponding to a geographic location;
receiving a semantic vector tile comprising vector data and semantic metadata, the vector data corresponding to the geographic location, and the semantic metadata corresponding to the vector data; and
providing for display information associated with the semantic vector tile.

18. The one or more computer-readable media of claim 17, wherein the semantic vector tile comprises a plurality of layers, and wherein the semantic metadata comprises semantic metadata for each layer of the plurality of layers.

19. The one or more computer-readable media of claim 18, wherein, for each layer, the layer comprises elements of a feature, and the semantic metadata for the layer comprises, for each element of the feature, a type of the feature.

20. The one or more computer-readable media of claim 17, wherein the semantic metadata comprises an indicator of at least one of a road type, a building use, a type of transit infrastructure, a type of land use, a type of water body, or a prominence of a point of interest.
